(19) United States
(12) Patent Application Publication
(10) Pub. No.: US 2009/0217631 A1
(43) Pub. Date: Sep. 3, 2009

(54) ANTI-FLINCH COLLAR FOR USE ON SPORTS EQUIPMENT

(76) Inventors: David E. J. PEPIN, Grant Park, IL (US); Matthew D. Pepin, Kankakee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/041,428

(22) Filed: Mar. 3, 2008

(51) Int. Cl. B01D 9/00

(52) U.S. Cl. 55/357

(57) ABSTRACT

An anti-flinch collar for use on a handle portion of a sports device includes a collar (100) having a substantially cylindrical shape and forming a bore (202) extending axially therethrough. The bore (202) is adapted to surround a segment of the handle portion and retain the collar (100). A plurality of anti-flinch features (112) is formed along an outer surface (206) of the collar (100). The collar (100) is adapted to engage at least one finger of a holder of the handle portion to prevent flinching of the at least one finger.

### TECHNICAL FIELD

This patent disclosure relates generally to anti-flinch devices and features for handles used on sports equipment and, more particularly, to removable and/or adjustable collars having anti-flinch features for installation on handles.

### BACKGROUND

Anti-flinch features are ribs or other features formed on surfaces of hand-held devices when a stable grip by the user is desired. Flinching is a reflex involuntary motion of the human hand when a sudden motion is anticipated by the user. Known applications of anti-flinch features are common in handguns, where ribs or notches are formed on the trigger guard of the weapon. These features aid the stable grip on the weapon by the shooter, especially when using both hands to grip the weapon.

Even though application of anti-flinch features on weapons relates to safety of the user and of others, a stable grip on a hand-held device or a handle of a device is not practical because of the variable requirements of each user. For example, golf clubs are instruments used in a sport that requires a stable grip and accuracy but, unlike a handgun, most users tend not to grip the handle in a consistent fashion, making use of anti-flinch features difficult. In other words, a positioning of the anti-flinch features that will suit some players may be uncomfortable to others. This holds true even for other sports, for example, baseball, tennis, and so forth, where sports instruments having handles are used in sports requiring considerable degrees of accuracy and a stable grip.

### SUMMARY

This disclosure provides, in one aspect, an anti-flinch collar for use on a handle portion of a sports device. The device includes a collar having a substantially cylindrical shape and forming a bore extending axially therethrough. The bore is adapted to surround a segment of the handle portion and retain the collar. A plurality of anti-flinch features is formed along an outer surface of the collar. The collar is adapted to engage at least one finger of a holder of the handle portion to prevent flinching of the at least one finger thus improving the stability and grip of the user.

In another aspect, the disclosure provides a sports instrument, for example, a golf club, racquet, baseball bat, and so forth, that includes an elongate handle. A collar is inserted around a segment of the elongate handle, the location of which is adjustable. A plurality of anti-flinch features is formed along an outer surface of the collar. The anti-flinch features formed on the collar are adapted to engage at least one finger of a holder of the elongate handle to prevent flinching.

In yet another aspect, the disclosure provides a method of stabilizing a person's grip on a handle of a sports instrument. The method includes inserting an anti-flinch attachment around a portion of the handle at an axial location. The user may then grip the handle with both hands such that at least one finger contacts a plurality of features formed externally to the anti-flinch attachment.

### BRIEF DESCRIPTION OF THE SEVERAL VIEWS OF THE DRAWINGS

FIGS. 1 and 2 are outline views from different perspectives of a collar installed on a grip of a golf club in accordance with the disclosure.

FIGS. 3 and 4 are outline views of a collar in accordance with the disclosure.

FIG. 5 is a section view of a collar in accordance with the disclosure.

FIGS. 6 through 8 are section views of different embodiments of collars in accordance with the disclosure.

FIGS. 9 through 11 are outline views of different sports equipment having collars installed thereon in accordance with the disclosure.

### DETAILED DESCRIPTION

This disclosure relates to a device for use with sports equipment to improve stability and accuracy of their use by a user. The device may be applied to any sports device that incorporates a grip that requires control of rotational accuracy on the part of the user. The device disclosed can be generally characterized as a removable and/or adjustable collar that is insertable or attached on a handle and whose position on the handle may be adjusted to suit the preference of the user. The collar may be made of a pliable material that conforms to the shape and yields to the pressure exerted thereon by the hand of the user as the user grips the handle. The collar also forms external ribs or other features that operate to stabilize the user's grip by reducing flinching of one or more of the user's fingers. These anti-flinch features advantageously increase the grip strength and consistency of the handle by the user and improve the user's performance when using the sports device. The embodiment for a collar disclosed herein relates to use on a handle of a golf club but, as can be appreciated, the collar is suited for use on other instruments as well. A few examples of different uses are described and shown toward the end of the disclosure for purposes of illustration.

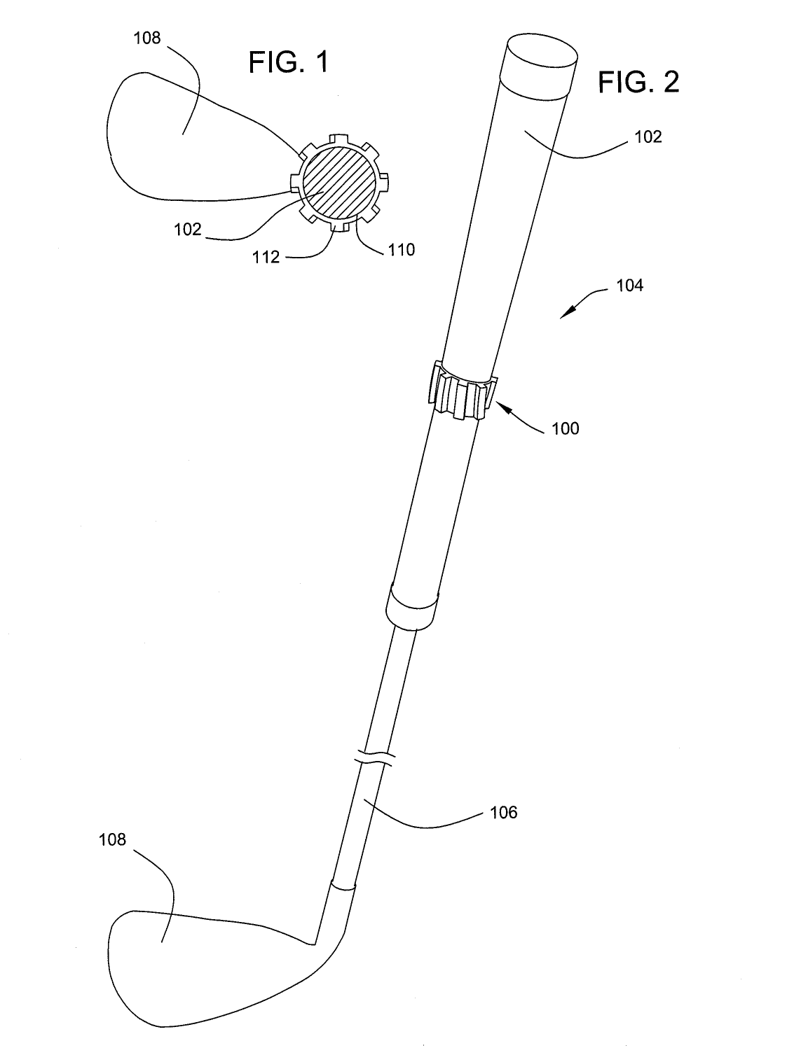

Two outline views, from different perspectives, of a collar 100 installed onto a lance or grip 102 of a golf club 104 are shown in FIG. 1 and FIG. 2. The club 104 is a typical club including a shaft 106, a portion of which is surrounded by the grip 102. A head 108 is connected to the shaft 106 and used to strike a ball (not shown) when a user holding the grip 102 swings the club 104. The grip 102 on a typical club must have a circular cross section according to various rules governing the game of golf. However, the grip 102 may and often tapers from thick to thin along its length.

During use of the club 104, the user holds the grip 102 with both hands and swings the club 104 in a sweeping motion to strike a ball. Steadiness and accuracy of the user's grasp of the grip 102 is important for an accurate shot. The collar 100 can be installed and used, for example, when the user is practicing. During use, the user may grasp the grip 102 in substantially a typical fashion, but also make use of the anti-flinch characteristics provided by the collar 100. Specifically, one of the user's hands may hold the grip 102 along a portion thereof above the collar 100 and make no contact with the collar 100. The palm of the user's other hand may then touch the grip 102 in an area just above the collar. The user may then close the fingers of the second hand around at least a portion of the collar 100 such that at least a part of one or two fingers, for example, the index finger and/or the middle finger, come into contact with the various anti-flinch features formed externally on the collar 100. The one or two fingers of the user may surround the collar 100 at the same time as they surround the grip 102. This contact between the collar 100 and the user's fingers creates a tactile sensation to the user that aids in maintaining a steady grip on the club 104.

In this embodiment, the collar 100 is made of a flexible or elastic material that can conform to the tapering shape of the grip 102 along any axial location thereof. Alternatively, the collar may be made of a non-flexible or inelastic material having any shape that appropriately affixes itself onto a handle of a particular article of sports equipment. Moreover, the collar 100 may advantageously have an inner diameter that is smaller than an outer diameter of the grip 102 such that it can contract around any segment of the grip 102 and retain its position thereon. The collar 100 includes a core portion 110 used internally to attach the collar 100 to the grip 102 and externally to form anti-flinch features 112 arranged to contact one or more fingers of the user when the user is holding the grip 102.

The anti-flinch features 112 may be any type of protrusion from the handle that will create an “anti-flinch” tactile sensation on the hand of the user that is at least slightly different than the expected tactile sensation created by the handle or grip of the sports equipment on the rest of the hand and/or the other hand of the user. This tactile differentiation helps the user maintain awareness of his grip and concentrate on holding the handle, which yields an overall more stable grip. In some instances, for example, where a user practices using the sports equipment often, different collars having different anti-flinch features 112 creating different tactile sensations may be used, in an alternating fashion, to retain the anti-flinch effectiveness on the user.

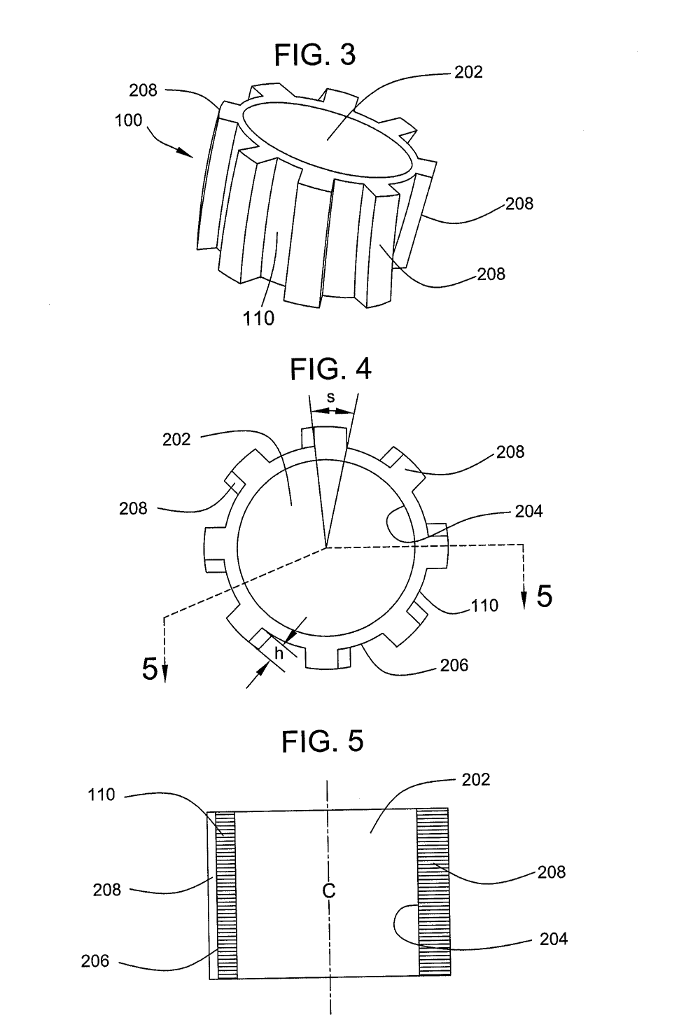

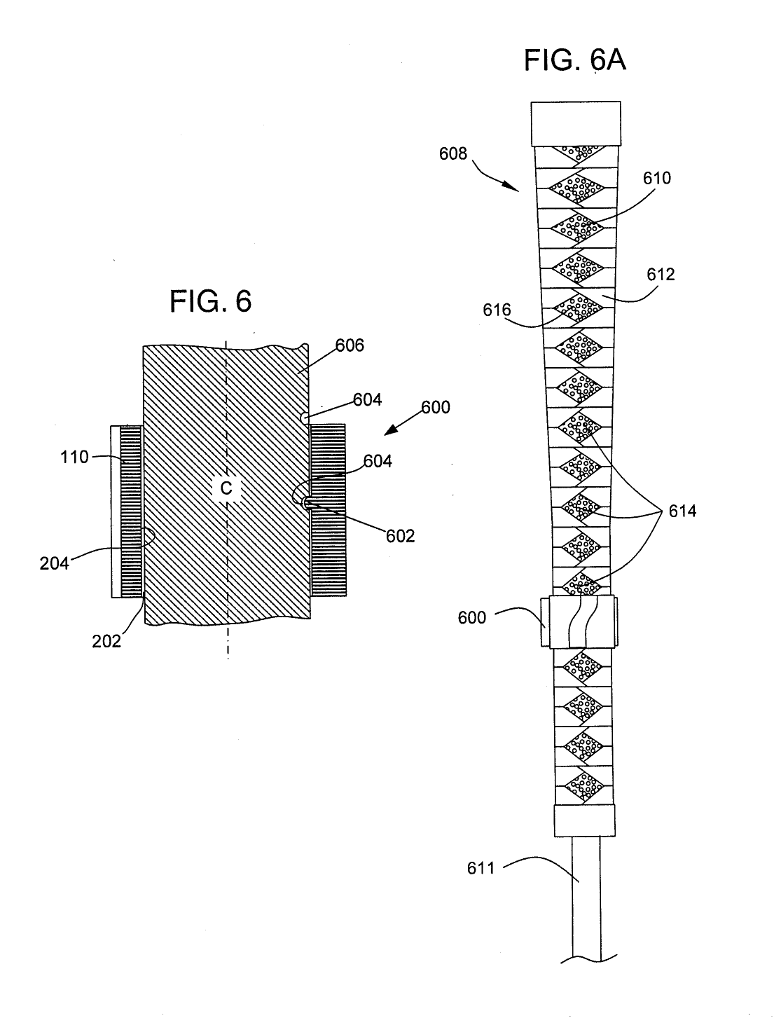

Various outline views and a cross section of the collar 100 are shown in FIGS. 3 through 5. The collar 100 has a hollow cylindrical shape that forms a central opening 202. Even though the collar 100 as shown has a continuous cylindrical shape, alternative embodiments can include collars having gaps or openings along their periphery. Such collars may peripherally surround only a segment of the handle's outer surface at any cross section along the handle.

Here, the central opening 202 has a circular cross section that accommodates the grip 102 when the collar 100 is installed onto the club 104. Handles having differently shaped cross sections may have collars used thereon having differently shaped central openings such that an adequate fit is maintained between the collar and the respective handle. The core portion 110 surrounds the central opening 202 along a wall or internal surface 204. An outer surface 206 of the core portion 110 forms a plurality of anti-flinch features 112. In this embodiment, the anti-flinch features 112 are a plurality of ribs or ridges 208 that protrude from the outer surface 206 by a height, h, and occupy a segment, s, of the periphery of the outer surface 206. As can be seen more clearly in FIG. 3, each ridge 208 extends generally axially along the length of the collar 100 but follows a curved or helical path. Alternatively, of course, the ridges 208 could extend parallel to each other along a centerline, C, of the collar 100.

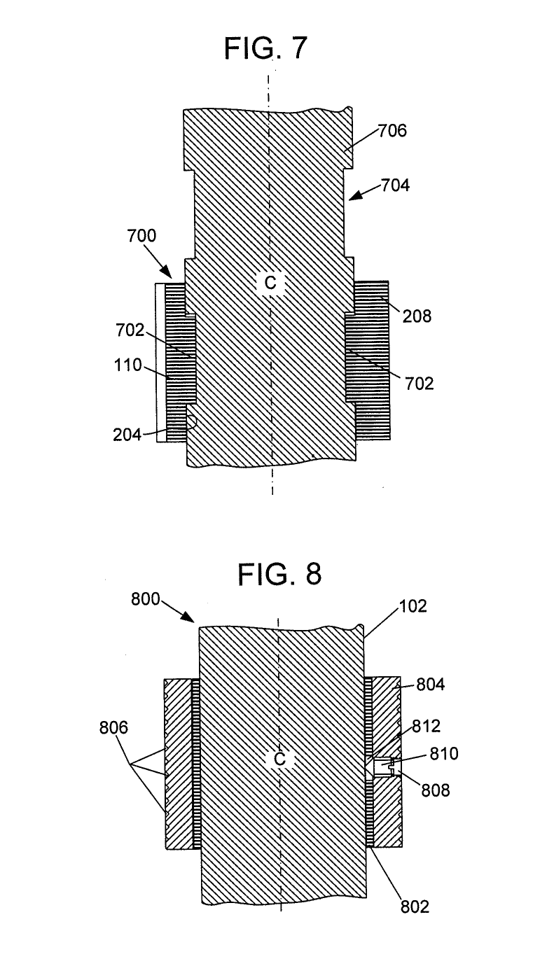

Even though the collar 100 in the illustrated embodiment is made of an elastic material that contracts around the handle for retention, repeated use may cause the collar to move or “walk” along the handle. For this reason, additional and/or different features may be used to help the collar remain on the handle at the installed position during use. Three alternative embodiments for retention features formed on collars are shown in FIGS. 6 through 9. In the description of these embodiments, like reference numerals are used to describe the same or similar features as the embodiment of the collar 100 described thus far and shown in FIGS. 1-5, for the sake of simplicity.

A first alternative embodiment for a collar 600 is shown in FIG. 6. The collar 600 forms at least one positioning and/or retaining feature 602 on the internal surface 204. In this embodiment, the retaining feature 602 is a protrusion that is unitarily formed with the collar 600 and protrudes radially inward toward the centerline C. The retaining feature 602 is arranged to mate with a receiver feature 604 formed in the grip 606 of a club. In this embodiment, the receiver feature 604 is a shallow opening or hole formed in the grip 606. As shown in FIG. 6, the grip 606 forms a series of receiver features 604 along its length that are spaced apart and arranged to accept the retaining feature 602 to allow for alternative placements of the collar 600 on the grip 606 by the user. When the retaining feature 602 is disposed within the receiver feature 604, the collar 600 is retained onto the grip 606 in a manner that resists twisting and/or axial motion of the collar 600 relative to the grip 606.

A variation on the grip 606 for this embodiment is shown in FIG. 6A. In this alternative embodiment, the grip 608 of the club has leather or another suitable material woven onto the grip in a manner improving the hold of the user on the club as well as creating a more aesthetic appeal. For example, the grip 608 shown here emulates a leather-bound weaving pattern commonly found on the handles of Japanese swords. In this embodiment, a weave is used that includes an inner layer 610 of material having an uneven texture, for example, stingray skin. The inner layer 610 is wrapped around the shaft 611 of the club. The inner layer may be a sheet of material that is wrapped around the club or may, alternatively, be a sock or tubular piece of material that is worn over the grip portion of the shaft 611.

After the inner layer 610 has been installed, an outer layer 612 is installed to finish the grip 608. The outer layer 612 may be constructed from a strip of material or “Ito” that is made of a pliable material, for example, leather, cotton, or silk, and that is woven around the inner layer 610 to form a pattern. The pattern forms knots leaving a plurality of openings or notches 614 that extend through the outer layer 612 and expose segments 616 of the inner layer 610. These notches 614 advantageously define the receiver features 604 along the length of the grip 608 that mate with the retaining feature 602 of the collar 600, and may also improve the firmness of the holders grip. An exemplary pattern includes, but is not limited to, a criss-cross lacing pattern (See FIG. 6A). As can be appreciated, other styles of Japanese sword handle constructions or weaves having notches defined therein are possible.

A second alternative embodiment for a collar 700 is shown in FIG. 7. The collar 700 forms at least one positioning and/or retaining feature 702 on the internal surface 204, which in this embodiment is a cylindrical ring that is unitarily formed with the collar 700 and protrudes radially inward toward the centerline C along the entire circumference of the central opening 202. The retaining feature 702 is arranged to mate with a receiver feature 704 formed in the grip 706 of a club, which in this embodiment is a shallow channel or recess formed in the grip 706 that extends peripherally around an entire segment of the grip 706. As shown in FIG. 7, the grip 706 forms a series of receiver features 704 along its length that are spaced apart and arranged to accept the retaining feature 702 to allow for alternative placements of the collar 700 on the grip 706 by the user. When the retaining feature 702 is disposed within the receiver feature 704, the collar 700 is retained onto the grip 706 in a manner that resists axial motion of the collar 700 relative to the grip 706, but may permit at least some twisting motion therebetween.

A third alternative embodiment for a collar 800 is shown in FIG. 8. In the embodiments described thus far, the collars were constructed as unitary structures made of an elastic or deformable material. Hence, the ribs or anti-flinch features 112 formed thereon were made of the same material. As a matter of personal taste, some users prefer or find it more effective to have a more rigid feel to the anti-flinch features formed on the collar. For this reason, the collar 800 includes both a flexible portion, to accommodate for the tapering of the grip, as well as a rigid portion that forms rigid anti-flinch features.

The collar 800 includes an inner core 802, which is made from an elastic or collapsible material, and an outer ring 804 made from a resilient material, for example, thermoset plastic or metal. The outer ring 804 forms a series of shallow grooves 806 on its outer surface that act as the anti-flinch features. The grooves 806 may take on any desired or appropriate shape, for instance, helical, parallel or perpendicular to the centerline C, and may even be formed in a crosshatch pattern.

Optionally, the collar 800 can be adapted for a more permanent installation onto the grip 102. In this embodiment, the outer ring 804 forms a threaded hole 808 that accommodates a setscrew 810. The setscrew 810 can access the grip 102 through an opening 812 formed through the inner core 802 such that, when the setscrew 810 is tightened, the collar 800 is rigidly engaged with the grip 102. Use of a setscrew or any other retention device advantageously makes the collar 800 suitable for use on any type of grip because no additional retention features are required. Of course, the setscrew or any of the other retention features disclosed herein may be replaced, for example, by adhesives or epoxies that can create a more permanent bond between a grip and a collar.

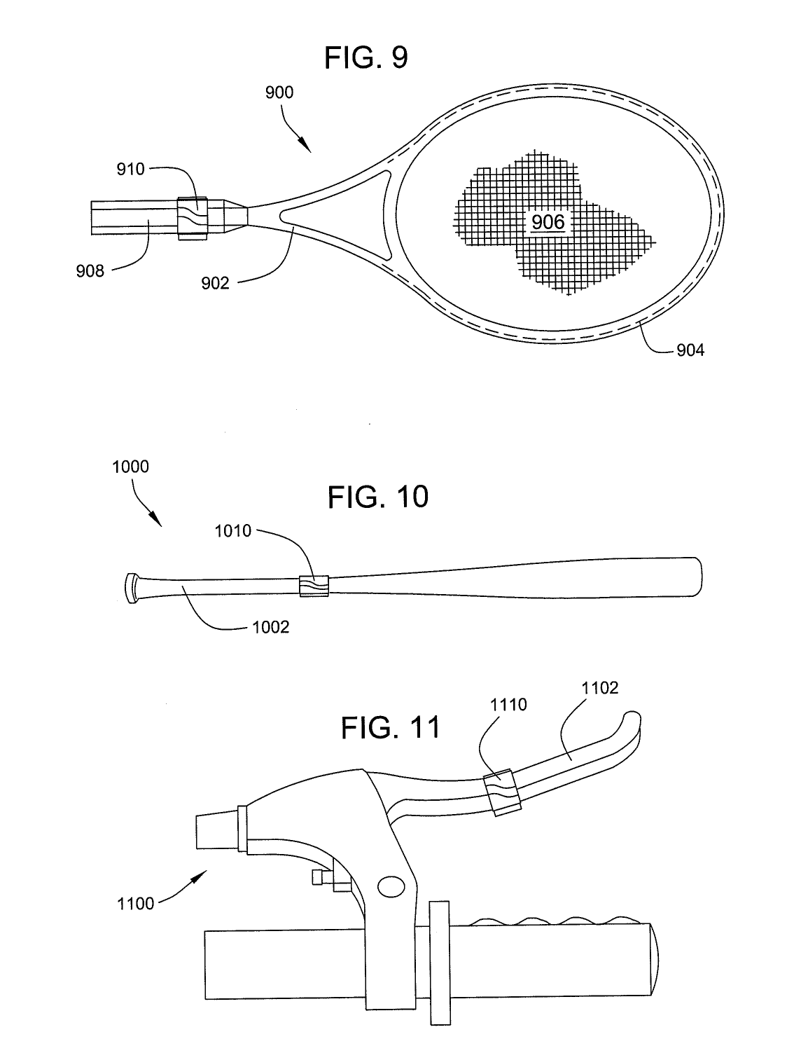

The disclosure above uses a golf club as one exemplary application of an anti-flinch collar used on sports equipment. As can be appreciated, however, other sports and their related equipment are suited for use of collars as well. Three examples of various other applications of sports equipment suited for accommodating anti-flinch collars are shown in FIGS. 9 through 11. These examples are not meant to represent an exhaustive list of equipment, but are merely shown for illustration.

A racquet 900 is shown in FIG. 9. The racquet 900 includes a handled frame 902 with an open hoop 904 across which a network of cord 906 is stretched. The racquet 900 is of the type used for striking a ball in such games as squash, tennis, racquetball, badminton, and so forth. A handle 908 formed on the handled frame 902 is held by a player during play. To improve the stability of the player's grip on the handle 908, an anti-flinch collar 910 having features similar to the collars described thus far can be adjustably and removably inserted around a segment of the handle 908.

In a similar fashion, an anti-flinch collar 1010 is shown inserted around a segment of a handle portion 1002 formed on a baseball bat 1000. An additional example of a collar 1 110 is shown inserted over a segment of a brake bar 1102 that is part of a bicycle handle 1100. One can appreciate that other applications are possible where stability of a user's grip is desired. The ease of installation and effectiveness of such collars having anti-flinch features makes them suitable for any application.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An anti-flinch device for use on a handle portion of a sports device, comprising:
a collar forming a bore extending axially therethrough, the bore adapted to at least partially surround a segment of the handle;
a plurality of anti-flinch features formed along an outer surface of the collar;
wherein the collar is adapted to engage at least one finger of a holder of the handle when the holder is holding the handle portion, such that at least one of the plurality of anti-flinch features contacts the at least one finger of the holder thereby creating an anti-flinch tactile sensation for the holder that is different than an expected tactile sensation otherwise created by the handle, which difference between the anti-flinch tactile sensation and the expected tactile sensation prevents flinching of the at least one finger.

2. The anti-flinch collar of claim 1, wherein the collar is made of an elastic material that is adapted to conform to a tapering shape of the handle.

3. The anti-flinch collar of claim 1, wherein the collar defines a core portion that forms the bore, the core portion defining the outer surface, wherein the plurality of anti-flinch features are formed on the outer surface of the core portion.

4. The anti-flinch collar of claim 1, wherein the collar has a hollow cylindrical shape, and wherein the bore has a circular cross section.

5. The anti-flinch collar of claim 1, wherein the plurality of anti-flinch features is a plurality of ridges that protrude radially outward with respect to the bore.

6. The anti-flinch collar of claim 5, wherein the plurality of ridges extend generally axially along a length of the collar following a curved path.

7. The anti-flinch collar of claim 5, wherein the plurality of ridges extend parallel to each other along a centerline of the collar.

8. The anti-flinch collar of claim 1, further including a retaining feature formed along an internal surface of the bore.

9. The anti-flinch collar of claim 8, wherein the retaining feature is adapted to engage a receiver feature formed on the outer surface of the handle portion.

10. The anti-flinch collar of claim 9, wherein the handle portion includes an inner layer made of a material having a rough texture, and an outer layer forming a plurality of notches that extend therethrough, each of the plurality of notches exposing a respective segment of the inner layer, wherein the plurality of notches are at least the receiver feature formed on the outer surface of the handle portion.

11. The anti-flinch collar of claim 1, wherein the collar is adapted to surround a portion of a handle formed on at least one of a golf club, a racquet, a bat, and a brake lever.

12. A sports instrument, comprising:
an elongate handle;
a collar disposed at least partially around a segment of the elongate handle, a location of the collar axially along the elongate handle being adjustable;
a plurality of anti-flinch features formed along an outer surface of the collar;
wherein the collar is positioned on the elongated handle to engage at least one finger of a holder of the elongate handle when the instrument is in play, such that at least one of the plurality of anti-flinch features contacts the at least one finger of the holder thereby creating a tactile sensation for the holder, which prevents flinching of the holder during play.

13. The sports instrument of claim 12, wherein the collar is made of an elastic material that is adapted to conform to a tapering shape of the segment of the elongate handle.

14. The sports instrument of claim 12, wherein the collar defines a core portion that forms a bore, and wherein the segment of the elongate handle is disposed in the bore.

15. The sports instrument of claim 14, wherein the collar has a hollow cylindrical shape, and wherein the bore has a circular cross section.

16. The sports instrument of claim 14, wherein the plurality of anti-flinch features is a plurality of ridges that protrude radially outward with respect to the bore.

17. The sports instrument of claim 16, wherein the plurality of ridges extend generally axially along a length of the collar following a curved path.

18. The sports instrument of claim 12, wherein the sports instrument is at least one of a golf club, a racquet, a bat, and a brake lever.

19. The sports instrument of claim 12, wherein the elongate handle includes an inner layer made of a material having a rough texture, and an outer layer forming a plurality of notches that extend therethrough, each of the plurality of notches exposing a respective segment of the inner layer, wherein the plurality of notches define a plurality of receiver features along the elongate handle that are arranged to engage and retain the collar.

20. A method of stabilizing a person's grip on a handle of a sports instrument, comprising:
inserting an anti-flinch attachment around a portion of the handle at an axial location;
gripping the handle with one hand;
gripping the handle with another hand such that at least one finger contacts a plurality of features formed externally to the anti-flinch attachment.
